(19) United States
(12) Patent Application Publication
(10) Pub. No.: US 2018/0210546 A1
(43) Pub. Date: Jul. 26, 2018

(54) POSE-INVARIANT EYE-GAZE TRACKING USING A SINGLE COMMODITY CAMERA

(71) Applicant: XLABS PTY LTD, Victoria (AU)

(72) Inventors: David John Rawlinson, Melbourne (AU); Alan Miao Zhang, Melbourne (AU)

(21) Appl. No.: 15/315,612

(22) PCT Filed: Jun. 2, 2015
(86) PCT No.: PCT/IB2015/054161

§ 371 Date: Dec. 1, 2016

Related U.S. Application Data
(60) Provisional application No. 62/006,428, filed on Jun. 2, 2014.

(51) Int. Cl. G06F 3/01; G06K 9/00; G06T 7/73

(52) U.S. Cl. CPC G06F 3/013; G06K 9/00281; G06T 2207/30201; G06K 9/0061; G06T 7/73

(57) ABSTRACT

A method, comprising: (a) measuring coordinates of four or five fiducial markers in facial images of a subject captured by a camera facing away from a screen toward the subject; (b) optimising and reducing a multivariate polynomial model that maps the measured coordinates of the four or five fiducial markers in the facial images to estimated coordinates of gaze targets of the subject on the screen; and (c) using the reduced multivariate polynomial model to map the measured coordinates of the four or five fiducial markers to the estimated coordinates of gaze targets of the subject on the screen.

### FIELD

The present invention relates to polynomial model-based eye gaze tracking that balances accuracy and generality giving useful results without unreasonable calibration effort or restrictions on user pose and movement.

### BACKGROUND

Eye gaze tracking involves estimating the direction of gaze of a person. Gaze estimation is important for many commercially valuable applications including human attention analysis, human cognitive state analysis and gaze-based human-computer interaction.

Existing approaches to eye gaze tracking have various disadvantages. Most of them are either intrusive by requiring headgear or no head movement, or are impractical, such as those requiring extensive active calibration and high computation cost, or expensive infrared corneal reflection and stereovision.

In this context, there is a need for eye gaze tracking solutions that address or at least partially ameliorate the above problems.

### SUMMARY

According to the present invention, there is provided a method, comprising:

(a) measuring coordinates of four or five fiducial markers in facial images of a subject captured by a camera facing away from a screen toward the subject;

(b) optimising and reducing a multivariate polynomial model that maps the measured coordinates of the four or five fiducial markers in the facial images to estimated coordinates of gaze targets of the subject on the screen; and

(c) using the reduced multivariate polynomial model to map the measured coordinates of the four or five fiducial markers to the estimated coordinates of gaze targets of the subject on the screen.

The method may comprise performing steps (a) and (c) continuously, and performing step (b) only when calibration is required.

The four or five fiducial markers may comprise four or five facial landmarks that are invariant to head or face pose of the subject, non-collinear and non-parallel to an image plane of the camera. The four or five facial landmarks may comprise left and right inner canthi, an upper lip midpoint, and either one iris centre or an average of left and right iris centres.

The four or five facial landmarks may be detected and extracted from the facial images using a face-fitting algorithm.

The reduced multivariate polynomial model may comprise a fourth order polynomial model including two fourth order polynomial functions, one of which estimates x coordinates of the gaze targets on the screen, and the other of which estimates y coordinates of the gaze targets on the screen.

Step (b) may comprise starting with an initial polynomial function having a large number of terms, and iteratively removing terms and measuring prediction error until an optimal combination of prediction error and generalisation is achieved. The optimal combination of prediction error and generalisation may be achieved by removing terms until prediction error is greater than a predetermined fraction of original prediction error using all terms. The order of term removal may be determined by a greedy search over all terms, and removing individual terms that have least impact on accuracy for all terms.

The method may further comprise calibrating or training the reduced multivariate polynomial model by measuring image coordinates of the four or five fiducial markers when there is a high probability that the subject is gazing at known screen coordinates either incidentally or as a feature of a user interface. The known gaze targets may comprise cursor indicators, user selectable items or content objects displayed at known coordinates on the screen.

The screen may be a display of a computing device. The computing device may comprise a computer, a tablet or a smartphone.

The camera may be a video camera or a webcam.

The present invention also provides a computer program product stored on a non-transitory tangible computer readable medium and comprising instructions that, when executed, cause a computer system to:

(a) measure coordinates of four or five fiducial markers in facial images of a subject captured by a camera facing away from a screen toward the subject;

(b) optimise and reduce a multivariate polynomial model that maps the measured coordinates of the four or five fiducial markers in the facial images to estimated coordinates of gaze targets of the subject on the screen; and

(c) use the reduced multivariate polynomial model to map the measured coordinates of the four or five fiducial markers to the estimated coordinates of gaze targets of the subject on the screen.

### BRIEF DESCRIPTION OF DRAWINGS

Embodiments of the invention will now be described by way of example only with reference to the accompanying drawings, in which:

FIG. 1 is a flowchart of a method for computationally efficient and robust gaze tracking according to an embodiment of the invention;

FIG. 2 is a schematic perspective view of a system for implementing the method;

FIG. 3 is a schematic diagram of a face model as a rigid body;

FIG. 4 is a schematic diagram illustrating the geometry of a face, camera and screen; and

FIG. 5 is a schematic diagram of facial landmarks on a face;

FIG. 6 is a schematic diagram of a face eye model based on three facial landmarks; and

FIGS. 7 and 8 are schematic diagrams of example software architectures for implementing the method as middleware and back end components in a computer system.

### DETAILED DESCRIPTION

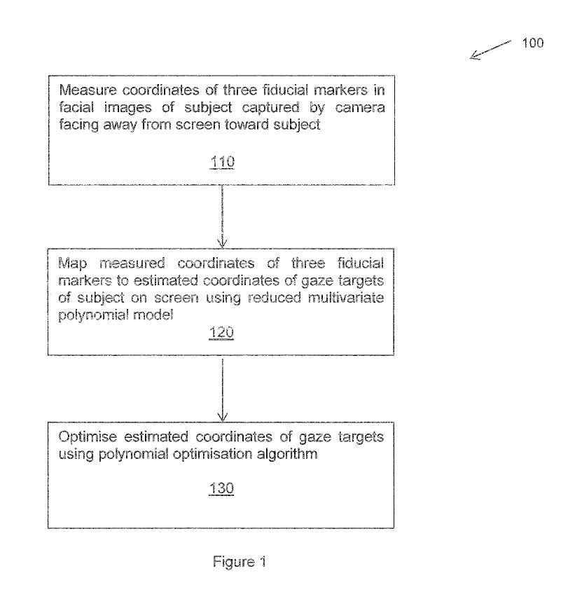

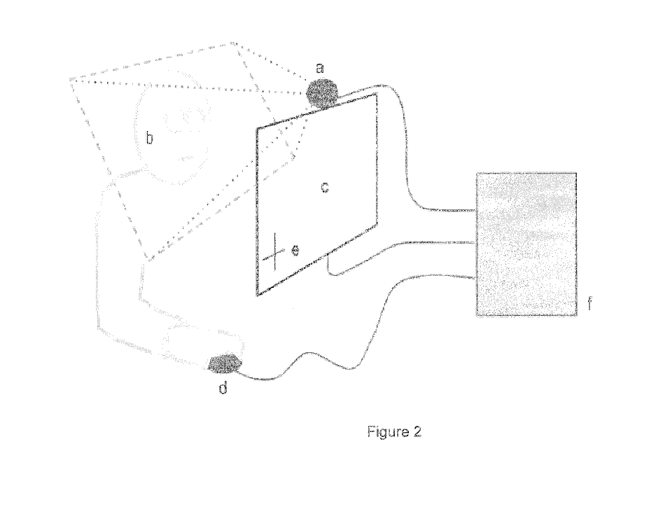

FIG. 1 is a flowchart of a method 100 for computationally efficient and robust eye gaze tracking according to an embodiment of the invention. Referring to FIG. 2, the method 100 starts at operation 110 by measuring coordinates of four or five fiducial markers in facial images of a subject (b) captured by a camera (a) facing away from a screen (c) toward the subject (b). The screen (c) may be a display of a computing device (f), such as a computer, a tablet or a smartphone. The camera (a) may be a video camera or a webcam. The subject (b) may gaze at a gaze target (e) on the screen (c) and interact with the computer (c) using an input device (d), such as a mouse or touchpad.

In use, the webcam (a) may capture a stream of facial images and is positioned so that the subject's face (b) is visible within the camera image. The subject's gaze may be measured at the gaze target (e) on the screen (c). For calibration or training, a set of correspondences between the subject's (b) facial appearance and the subject's (b) gaze coordinates within the gaze target (e) may be obtained. These correspondences may be captured either via a dedicated user interface, or incidentally while the user is interacting with an unrelated user interface for any purpose. In a dedicated user interface, correspondences can be generated either by recording subject (b) mouse or other positional input device (d) coordinates on screen, or by asking the subject to look at specific features displayed on screen. In an unrelated user interface, it may be assumed that mouse or pointer input device screen coordinates are similar to the subject's gaze position on-screen, for a short period of time before and after a click or tap interaction. It may be assumed that calibration outlier-rejection methods will handle exceptions to this rule. Software running on the computer (f) may process these data and, after calibration, provide a continuous stream of subject gaze data.

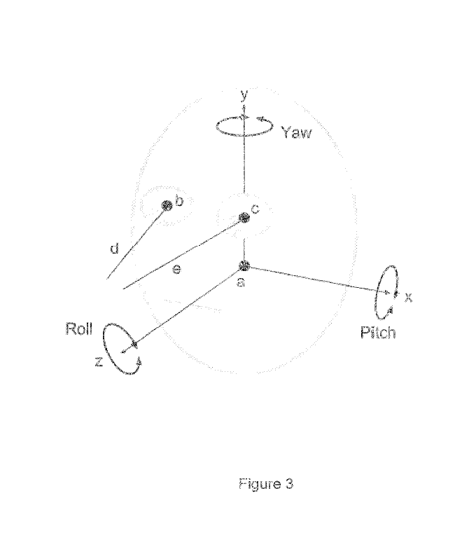

Referring to FIG. 3, it may be assumed that the part of the face containing relevant features is a rigid body whose pose has six degrees of freedom (DoF), namely translation and rotation in three spatial dimensions. These may be defined with respect to an arbitrary origin at the centre of the head (a). It may be assumed that all rotations have the same origin although this is not biologically accurate. The six DoF may be treated as variables within the system. FIG. 3 also shows gaze lines (d),(e) originating at eyeball centres (b),(c). These lines may define the relationship between head and world coordinates in the system.

The following assumptions may be made.
The relationship between the camera (a) and gaze-target (screen (c)) is fixed. If this relationship is changed (for example if a camera is moved relative to a screen), the system must be re-calibrated.
At least some parts of the face of the subject (b) constitute a rigid body moving in three dimensions. Although this assumption is not strictly true due to changes in facial expression, the latter has only minor and transient effect on gaze tracking accuracy.
The face of the subject (b) is visible to the camera (a). The system will not function at times when this assumption is not true.
Reasonable incidental illumination of the face with visible light. The system will not function at times when this assumption is not true.
The existence of correspondences between subject (b) facial appearance and gaze focus (e) on the screen (c). In other words, the system assumes that the subject (b) looks at specific coordinates within the gaze target (c) at known times. The correspondences permit calibration of the system.
The yaw and pitch of the eyes (b),(c) must be measured with respect to a reference point. This implies that the pose of at least one fixed reference point on the head or face (b) must be known. If the eyeball centre is not observable, a proxy reference must be used instead.

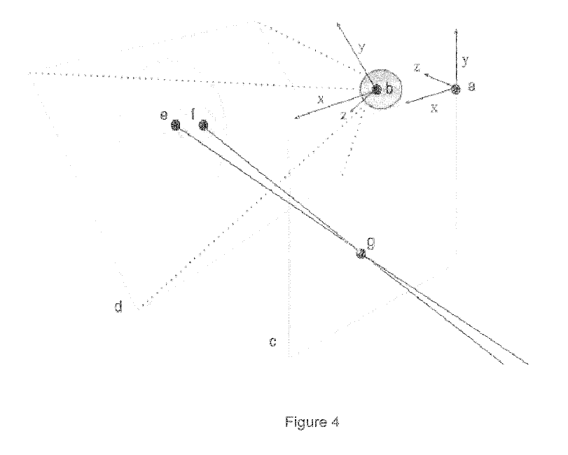

FIG. 4 illustrates the relationship between subject eyeballs, camera coordinates and a gaze target (eg, a screen). The world coordinate system may have an origin at the top corner of the gaze target (a). The camera coordinate system may have an origin inside the camera (b). Two planes are shown: the gaze target (c); and the camera image plane (d). Gaze lines originate at the subject's eyeball centres (e),(f), travel through the pupils, and intersect the gaze target at a common point (g), assuming normal vergence. Camera coordinates may be related to world coordinates via the rigid transformation T^{WC} which remains fixed using normal use. Camera coordinates and face coordinates may related via the rigid transformation T^{CF}. This transform encodes the face pose relative to the camera. T^{CF} changes as user moves their head during normal use of the system.

The problem is to recover the gaze location on the gaze target given measurements of subject appearance in an image. It may be assumed that both eyes look at the same point on the gaze target. This allows solving for one eye. Assuming the three-dimensional (3D) position of the eyeball centre and iris centre may be recovered in world coordinates, the point of intersection may be solved as follows:

$${U}_{Gaze}^{W} = \frac{{P}_{Iris}^{W} - {P}_{Eye}^{W}}{\vert {P}_{Iris}^{W} - {P}_{Eye}^{W} \vert}$$

where P_{Iris}^{W} and P_{Eye}^{W} are the iris centre and eyeball centre respectively, in world coordinates. U^{W} is a unit vector pointing in the gaze direction from the eyeball centre. A unit vector is used here to highlight the fact that gaze direction contains 2 DoF.

Parameterising the gaze line find:

P^{W}(t)=P_{Eye}^{W}+t*U^{W}

where t is the variable the line is parameterised on.

By definition, any point on the gaze target has a z value of zero. Therefore, the intersection on the gaze target may be solved using:

$$0 = {P}_{Eye}^{W} {\vert}_{z} + t * {U}^{W} {\vert}_{z} \text{=>} t = \frac{- {P}_{Eye}^{W} {\vert}_{z}}{{U}^{W} {\vert}_{z}}$$

Substituting t back gives the (x,y) coordinates of the target point on the gaze target:

$${P}_{Target}^{W} \vert ( x , y ) = {P}_{Eye}^{W} \vert ( x , y ) - \frac{{P}_{Eye}^{W} {\vert}_{z}}{{U}^{W} {\vert}_{z}} {U}^{W} \vert ( x , y ) \qquad ( Equation 1 )$$

The remaining problems are the recovery of eyeball centre and iris centre in world coordinate system. Eyeball centre is a function of the face pose, and iris centre is function of both face pose and gaze direction. The target point could be solved using the equations above if both iris and eyeball centre could be measured directly from the image. However, the eyeball centre is not directly observable from the image. It is necessary to use other, observable features on the face to infer the location of the eyeball centre. The location of these face features, as well as that of the eyeball centre, may be defined in the face coordinate system. Given correspondences of the face features in face coordinate system and in the camera image, the face pose, or equivalently the face coordinate to camera coordinate transform T^{CF}, may be recovered. This transform may be applied to the eyeball centre location in the face coordinate system, to convert it into the camera coordinate system:

P_{Eye}^{C}=T^{CF}(P_{Eye}^{F})

The iris location in camera coordinates (P_{Iris}^{C}) may be recovered from image measurements given the radius of the eyeball. Applying T^{WC} to both results in P_{Eye}^{W} and P_{Iris}^{W} as required in Equation 1.

The above formulation includes both variables that change during normal use, and parameters that do not change but are unknown. The variables and parameters are listed in the following table.

| | | Degrees of |
|---|---|---|
| Variable description | Notation | Freedom (DoF) |
| Face pose | T^{CF} | 6 |
| Gaze direction | U_{Gaze}^{W} | 2, a unit vector |
| Parameter description | Notation | Degrees of |
| | | Freedom (DoF) |
| Camera to World Transform | T^{WC} | 6 |
| Camera focal length | F_{cam} | 1 |
| Camera principal point | P_{cam} | 2 |
| Face Model | A set of at | At least 6 for a |
| | least 3 points | unique solution |
| Eyeball relative position | P_{Eye}^{F} | 3 |
| Eyeball Radius | P_{Eye-radius} | 1 |

The parameters are required in order to recover the variables for every image in order to predict the target point. The purpose of calibration is to recover the above parameters, given a set of correspondences between images of the subject and known points on the gaze target.

In reality, the above formulation is far too simplistic. There are many sources of nonlinearities that would cause confounding errors given even tiny measurement errors. For example, the geometric features on the face are 3D structures, not surface marks. Their appearance changes depending on the viewing angle. The rigid body assumption is not valid if the subject makes any facial expressions. The iris measurements in the image are not the centre of the iris because the eyelids cover varying and significant portions of the iris, making accurate fitting of a circle impossible. Finally, the eyeball is not a perfect sphere and does not rotate about a fixed centre.

Referring again to FIG. 1, in light of the foregoing, the method 100 provides a n-th order multivariate polynomial model that maps measured coordinates of fiducial markers in the facial images to estimated coordinates of gaze targets of the subject on the screen. At operation 120, the n-th order multivariate polynomial model may be optimised and reduced to map the measured coordinates of the four or five fiducial markers in the facial images to estimated coordinates of gaze targets of the subject on the screen. The reduced multivariate polynomial model has a significantly reduced number of terms, and simplifies the problem into a form that:
captures and handles the nonlinearities in the real world;
has a computationally efficient optimal solution;
does not overfit given only limited calibration samples; and
possesses an adjustable trade-off between generality and accuracy.

At operation 130, the reduced multivariate polynomial model may be used to map the measured coordinates of the four or five fiducial markers to the estimated coordinates of gaze targets of the subject on the screen. The reduced multivariate polynomial model may map image measurements into target points in the form of two polynomials, one for each of the x and y ordinates of the target point:

P_{Target}^{W}|x=Qₓ(M)

P_{Target}^{W}|=Q_{y}(M) (Equation 2)

where Qₓ and Q_{y} are nth degree multivariate polynomials, and M is a vector of measurements that is derived from the image measurements.

During development of the reduced multivariate polynomial model it was initially considered that to model this system with adequate accuracy, a fifth degree polynomial was required. If all possible terms in a fifth degree polynomial were included, there would be ⁵⁺⁸C₈ or 1287 terms. In any practical quantity of training data, this would necessarily result in gross overfitting. The effective number of parameters was expected to be much less, even taking into consideration the nonlinearities. Therefore, the form of the polynomial was reduced or restricted by exploiting the known structure of the system.

Nonlinearities tend to require higher order terms, so therefore as many known nonlinearities as possible should be explicitly modelled. The projection of facial features onto the image, being a projective transformation, is such nonlinearity. The projective transformation (ie, T^{CF}) may be explicitly inverted to remove this source of nonlinearity. Structure from motion may be used to recover both the relative locations of the facial features as well as T^{CF}(ie, the face pose). Alternatively, geometric properties of the facial features may be exploited to approximately recover the face pose. The advantage of this latter approach is that it is much simpler. This approximate method is described further below.

In certain situations, some polynomial terms are not expected to have any significant or measurable variation. We can force the coefficients of these terms to zero to effectively exclude them from the polynomial, thereby increasing robustness at the cost of lowering invariance to these variables.

In general, the gaze of the subject may be determined for a given camera-screen system if the face pose and eye pose of the subject is known. Since the eyes move independently of the face, both face-pose and eye-pose are required to determine gaze. The pose of the eyes is limited to rotation in two axes, namely pitch and yaw. Eye pose may be measured from the position of either the iris or pupil features. In low-resolution images, or for people of dark eye colour, the pupil is often not visible. Therefore, iris position may be used as an input to eye pose calculation. However, in cases where the pupil is visible it may be used instead; ie, pupil position may be used as a replacement for iris position without any impact.

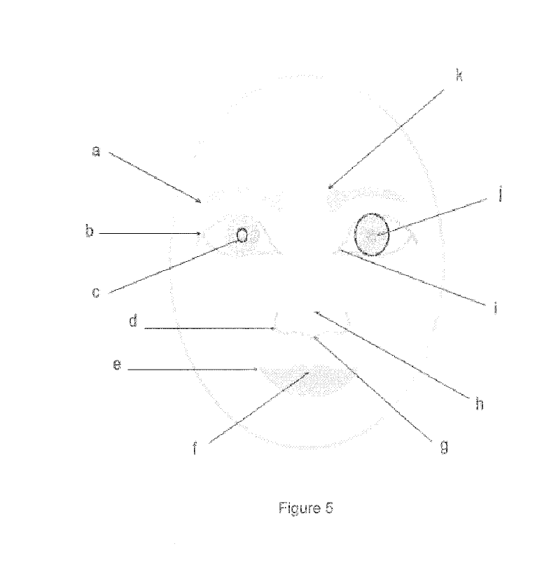

One method to determine the pose of the face is to measure the position of a set of fiducial marks (or facial landmarks) on the subject's face. These may be either artificial or natural features, and various selections of features may be used. However, it is desirable to use naturally occurring features that are common to all or most people. FIG. 5 shows some of the natural face features that may be used as fiducial markers. Different sets of these features have various advantages and disadvantages, especially in combination with the set of parameters needed to define a face model.

Features must be well localised on the face surface. Assume that there exists a pair of symmetrical facial features, such that a line joining them remains parallel (or as much as possible) to the image plane of the camera. This means that during normal use, where head movement is mainly yaw and pitch, changes in head orientation do not significantly alter the distance between these points in the image. It may therefore be assumed that the z value of the head location is inversely proportional to the distance between the pair of points in the image. A third point needs to be selected so that the plane spanned by the three points is as far from parallel to the image plane as possible. This ensures any yaw and pitch of the head causes large movements of this point relative to the other two. In other words, the facial landmarks may be selected so that they are invariant to head or face pose of the subject, non-collinear and non-parallel to an image plane of the camera.

Candidate features may include: (a) outer eyebrow tip; (b) outer canthi; (c) pupil centres; (d) nasal junction with cheek; (e) mouth corners; (f) centre of upper lip; (g) septum; (h) tip of nose; (i) inner canthi; (j) iris centres; and (k) inner eyebrow corner. Embodiments of the method 100 may use either (c) or (j) to measure eye pose in addition to face pose. Features (a), (d), (e), (g) are non-ideal because their apparent position is not invariant to face-pose. Feature (h) provides a lot of information about face-pose since it has a significantly different z coordinate to the eyes, so that yaw and pitch cause measurable changes in the relative position of the features; however, it is very difficult to locate accurately. Feature (k) is difficult to locate accurately and it does not provide much information about changes in pitch and yaw. Feature (b) is not an ideal fiducial point because the position of the feature is not invariant to pitch and yaw of the irises; the upper eyelid occludes the lower one when the subject's eyes pitch down. For these reasons, an embodiment of the method 100 uses features (f), (i) and (j); ie, the inner canthi (the junctions between the eyelids nearest the nose), the midpoint of the upper lip, and the irises. However, other combinations of fiducial features may be selected with consequent modifications to the face eye model described below.

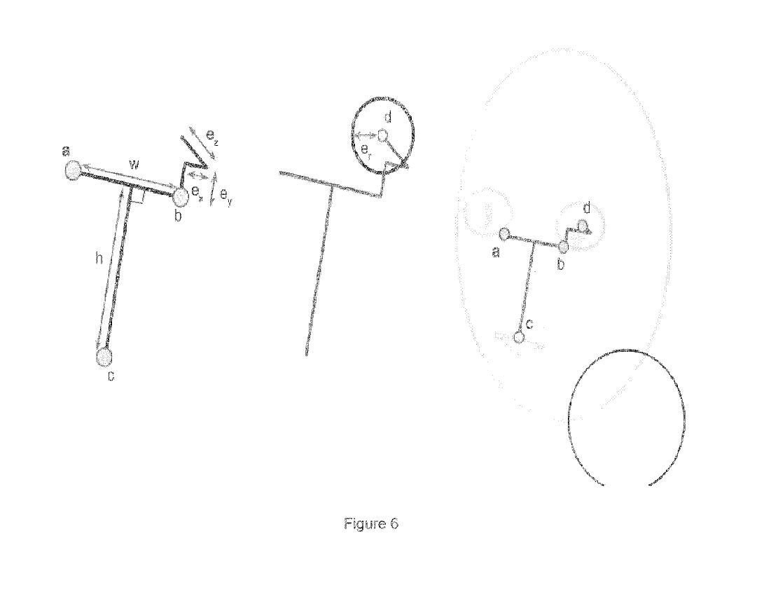

Referring to FIG. 6, to measure the pose of the subject's face in an image, the system must precisely locate some fiducial features. The feature set used affects the face-model that may be formed from them. The feature set also affects the accuracy of the complete system because some features provide more precise information about the pose of the face. Embodiments of the method 100 may incorporate a face model that describes the geometry of a specific subject's face. The face model may provide two pieces of data. First, it may provide a method of determining the subject's face pose by fitting the positions of known fiducial features of the face to the subject's appearance in camera images. Second, it may provide a reference point for measurement of the subject's eye pose.

It is desirable that the face model includes features well separated in all three dimensions. These large baselines ensure that even small head movements are very informative of face pose. A large baseline in the z-axis is particularly problematic, because most human faces are quite flat. The nose tip is a good candidate, but it is difficult to localise this feature accurately in images. Since the method 100 may automatically discover the parameters of the face model, it is desirable that the face model be as simple as possible with fewest unknowns.

Referring again to FIGS. 5 and 6, fiducial markers satisfying the constraints described above may be used to anchor the face model to the subject's appearance in a facial image. These are: (a) the left inner canthus; (b) the right inner canthus; and (c) the midpoint of the upper lip. These three features may be related by a T-shaped model that has only two parameters, namely the width of the space between the canthi (f_w) and the distance (f_h) between the midpoint of this line and the upper lip midpoint (c). To model the rotations of the eyeballs in relation to the face model, three translation parameters e_x, e_y and e_z are needed to define the eyeball centre. The radius of the eyeball e_r is also a parameter of the model. This model assumes that the subject's face is symmetric although this is not an essential feature. In other words, the method 100 may involve determining three facial landmarks comprising the two inner canthi, and the midpoint of the upper lip, to discover the face-pose. In addition, the face eye model of the method 100 also requires eye pose to be determined. This may be done with one of either left or right eye/iris centres, but the average of both left and right iris centres may be used to minimise error. So, therefore, the minimum number of features needed is four, comprising three face features and one eye pose feature, but the eye-pose may or may not be computed from both eyes (ie, potentially five discrete features total).

The face model may be anchored to face appearance via the two inner canthi (a), (b) and the midpoint of the upper lip (c). The parameters of this model are then face width and height (w),(h) and the three-dimensional offset to the centre of the eyeball from the inner canthus. The eyeball radius is also a parameter of the face-model. It is assumed that the face has bilateral symmetry. Due to the set of features used to anchor the face model to its appearance, even small rotational changes in any axis will result in measurable changes in feature position.

The features used to measure face and eye pose must be detected in images from the camera using a face-fitting algorithm. Embodiments of the method 100 involve detecting the inner canthi, the iris centres, and the midpoint of the upper lip with high precision. For maximum utility of the method 100, these must also be computed efficiently. Feature detection may comprise two parts. First, for example, cascades classifier using Haar-like features and an Active Shape Model (ASM) may be used to detect candidate faces and approximately locate facial features. Active Appearance Models (AAM) may be used as a replacement for the ASM without having any negative impact on the functioning of the method 100. Similarly, the face detector algorithm using Haar-like features and a cascade classifier may be replaced with any other face detection technique that localises face features with sufficient accuracy for gaze tracking. The accuracy of face-fitting using AAM/ASM may be supplemented by one or more fine localisation steps. In other words, depending on face-fitter accuracy, additional fine-tuning of feature location may be necessary. For example, sufficiently accurate iris detection may be provided by intensity projections or edge detection. Canthi may be detected with sufficient accuracy, for example, by:
normalising image scale using ASM features and crop to region around canthi;
using Laplacian of Gaussian (LoG) filtering to smooth and extract features of expected scale;
using Features from Accelerated Segment Test (FAST) feature detector to find corner-like features;
rejecting feature points based on geometric constraints relative to the ASM features; and
ranking results based on score.
   Other equivalent face-fitting methods, and feature detection and extraction techniques, may also be used.

The selected facial features may be tracked in the facial images by associating detection with tracks in previous frames (not all tracks are canthi). Tracked candidates in both left and right eye may be considered in combination to identify a pair of tracks as canthi when it satisfies a set of conditions on its stability, and geometric properties such as symmetry as well as feature scores.

The face model described above also works when alternative features are substituted for the ones selected above. However, as discussed, accuracy is affected by feature selection. In the case of subjects wearing glasses, two additional problems must be solved. First, the inner canthi features are obscured. Second, glasses' lenses distort the apparent position of the eyes. Note that neither problem occurs when contact lenses are used. Distortions in apparent iris position due to the glasses' lenses may be implicitly modelled in the calibration algorithm if the position of the glasses on the face does not change between calibration and use of the system. The frames of glasses themselves usually display several strong corner features on a surface coplanar to the face. These features are ideal replacements for the obscured canthi features. The face model already described may be used without modification if two features at the edges of the lenses are tracked instead of canthi features. However, since all glasses have frames with varying appearance, in the case of subjects with glasses it is necessary to train the system on the appearance of the glasses frames. This may be done by manually clicking on these features in the image of the subject captured from the camera, and initiating the tracker with these images.

Embodiments of the method 100 may use three points comprising the left and right inner canthi, and the midpoint of the upper lip, as discussed above. These points may be referred to as P_{Ref1}^{I}, P_{Ref2}^{I} and P_{Ref3}^{I}. This approximate face pose may then be used to normalise the other features as shown below:

$${P}_{Pseudo} {\vert}_{z} = \frac{1}{\vert {P}_{Ref 1}^{I} - {P}_{Ref 2}^{I} \vert} // proportional to world face depth$$

$${P}_{avg - ref}^{I} = \frac{1}{2} ( {P}_{Ref 1}^{I} + {P}_{Ref 2}^{I} )$$

$${P}_{Pseudo} {\vert}_{x} = {P}_{avg - ref}^{I} {\vert}_{x} * {P}_{Pseudo} {\vert}_{z} // proportional to world face position$$

$${P}_{Pseudo} {\vert}_{y} = {P}_{avg - ref}^{I} {\vert}_{y} * {P}_{Pseudo} {\vert}_{z} // proportional to world face position$$

$${ψ}_{Pseudo} = {tan}^{- 1} \frac{{P}_{Ref 2}^{I} {\vert}_{y} - {P}_{Ref 1}^{I} {\vert}_{y}}{{P}_{Ref 2}^{I} {\vert}_{x} - {P}_{Ref 1}^{I} {\vert}_{x}} // the roll of the face in the image$$

where theta is pitch, psi is roll and phi is yaw.

$${P}_{avg - iris} = \frac{1}{2} ( {P}_{Iris}^{I} + {P}_{Iris}^{I} ) // mid point between two detected iris // remove offset and roll from {P}_{Ref 3}^{I} and {P}_{avg - ref}^{I}$$

$${P}_{Ref 3}^{′} = R * ( {P}_{Ref 3}^{I} - {P}_{avg - ref}^{I} )$$

$${P}_{avg - iris}^{′} = R * ( {P}_{avg - iris}^{I} - {P}_{avg - ref}^{I} )$$

where R is a rotation matrix that rotates about the origin in the x-y plane by ψ_{Pseudo}.

Referring to Equation 2, the measurements M may be any vector derived from the image measurements as long as no information is lost. The new measurements may now be combined into a new measurement vector:

$${M}^{′} = [ \begin{matrix}{P}_{Pseudo} {\vert}_{x} \\ {P}_{Pseudo} {\vert}_{y} \\ {P}_{Pseudo} {\vert}_{z} \\ {ψ}_{Pseudo} \\ {P}_{Ref 3}^{′} {\vert}_{x} \\ {P}_{Ref 3}^{′} {\vert}_{y} \\ {P}_{avg - iris}^{′} {\vert}_{x} \\ {P}_{avg - iris}^{′} {\vert}_{y}\end{matrix} ]$$

Note that P_{Ref3}^{I}|(x,y) implicitly encodes the yaw and pitch of the head. Also note that in Equation 1, P_{Target}^{W} is scaled with P_{Eye}^{W}|_{z}, also with additive terms of P_{Eye}^{W}|ₓ and P_{Eye}^{W}|_{y} respectively. P_{Eye}^{W} may be approximated with P_{Pseudo}|(x,y,z). So these may be added explicitly as well:

P_{Target}^{W}|x=C0+C1*P_{Pseudo}|ₓ+C2*P_{Pseudo}|_{y}+Qₓ(M′)*P_{Pseudo}|_{z} (Equation 3)

P_{Target}^{W}|y=C0+C1*P_{Pseudo}|ₓ+C2*P_{Pseudo}|_{y}+Qₓ(M′)*P_{Pseudo}|_{z} (Equation 4)

P_{Pseudo}|ₓ and P_{Pseudo}|_{y} may be added to both P_{Target}^{W}|ₓ and P_{Target}^{W}|_{y} to allow for rotations in T^{WC}.

With these geometric constraints Q_{(x,y)}(M′) only needs to be third order to explain the system with reasonable accuracy. The total number of terms in each of Equations 3 and 4 is only 168. Thus, the problem has been dramatically simplified.

Due to the fact that P_{Target}^{W}|(x,y) are polynomials, the coefficients (ie, the parameters of the system) may be solved optimally in closed form. Assume there are enough calibration samples to uniquely solve for P_{Target}^{W}|(x,y). The problem may be expressed in the following form for each of P_{Target}^{W}|(x,y):

b=Ax (Equation 5)

where A=[M₁, M₂, . . . Mₙ]^{T}, where n is the calibration sample index, such that each row corresponds to a calibration sample, x is a vector containing the coefficients of the polynomial, and b is a vector containing the calibration sample's gaze target ordinate.

Equation 5 is an overdetermined system when there are more calibration samples than the number of polynomial coefficients. Singular value decomposition may be used to solve for x. This effectively minimises the L2 norm of the predicted target point and the calibration sample.

Alternatively, Equation 5 may be solved using the L1 norm, which is more resilient against outliers. For a L1 norm solution, Equation 5 may be recast as a constrained linear programming problem:

Minimise:
Σ_{z}

Subject to constraints:
z>=(Ax−b)
z>=−(Ax−b)

These constraints effectively implements: z=|Ax−b|

Rearranging the terms of the constraints:
Ax+z>=b
Az−z<=b

The above may be expressed in constrained linear programming canonical form:

$${A}^{′} = [ \begin{matrix}A , {I}_{n \times n} \\ A , - {I}_{n \times n}\end{matrix} ] [ \begin{matrix}b \\ b\end{matrix} ] = {A}^{′} [ \begin{matrix}x \\ z \\ x \\ z\end{matrix} ]$$

where:

$${A}^{′} = [ \begin{matrix}A , {I}_{nx} \\ A , - {I}_{nx}\end{matrix} ]$$

$$b = [ \begin{matrix}b \\ b\end{matrix} ]$$

and z>=0 (since z=|Ax−b|)

Any linear programming algorithm may be used to solve the above to obtain solutions for the polynomial parameters x. The L2 norm may be used in embodiments of the method 100.

Referring again to FIG. 1, the method 100 next moves to operation 130 by optimising the estimated coordinates of the gaze targets using a polynomial optimisation algorithm for discovery of system parameters. There are 168 terms in P_{Target}^{W}|(x,y). This means that at least 168 calibration correspondences are required for a unique solution. Using a smaller quantity of points will likely result in overfitting. Overfitting, in this domain, may be observable as a failure for the calibration parameters to generalise to unseen head and eye poses. Given that 168 correspondences represents an onerous calibration exercise, there exists a need for a mechanism to use fewer terms depending on the number of correspondences available. The number of terms may then be increased as the quantity of data increases, resulting in a good balance between calibration effort, accuracy and generality.

To determine the optimal number of terms for a given cardinality of correspondence set size, the polynomial optimisation algorithm may evaluate in simulation the generalisation behaviour for varying numbers of terms, and for all possible combinations of face poses and eye-gaze directions. This is an eight dimensional space and impossible to cover with real data samples. Instead, embodiments of the method 100 may use simulations to cover this space. During development of the method 100, the following strategies for sampling from this 8 dimensional space were evaluated: regular lattice, uniform random and uniform low-discrepancy. The regular lattice strategy led to severe aliasing. Uniform random does not sample the space very efficiently and evenly. In experiment, the uniform low-discrepancy gave best results.

Embodiments of the method 100 may use a training process comprising the following steps.
1. Allow all 168 terms and find the average prediction error (for example the L2 distance) on the set of simulated face pose.
2. Reduce the terms count by 1, then try to remove each term in turn.
3. Remove the term that causes the least increase in average prediction error.
4. Goto step 2 until no more terms left.
   This is a greedy approach but it works well in practice. The optimal solution is combinatorial and hence not feasible.

The result of training is a list of which terms to use when given a specified total number of terms available. Each time the system is calibrated, we perform an exhaustive search on the number of terms to use, such that the average prediction error goodness of fit of the chosen number of terms is within a fraction of the best achievable if using all 168 terms.

Embodiments of the method 100 may also provide false-correspondence filtering via outlier rejection. False correspondences represent situations where the measurements of a subject's appearance do not correctly correspond with the supplied gaze-target coordinates. This may occur for many reasons, including:
blurred images due to subject movement;
noncompliant subject;
subject blinking or facial occlusion;
invalid assumptions about subject behaviour during passive calibration; and
measurement feature localisation error.

During the calibration process, false correspondences have the appearance of outliers—correspondences where the predicted gaze target coordinates are grossly different to the supplied gaze-target coordinates. Outlier rejection is important, especially for the L2 norm. However, the same outlier rejection process may be used with both L1 and L2 minimisation. Embodiments of the method 100 may reject outliers via an iterative process. It may be assumed that the errors for each calibration point are normally distributed. The outlier rejection process is as follows:
1. solve for a set of parameters;
2. find the standard deviation of prediction error;
3. any samples that are outside “n” standard deviations are rejected;
4. goto step 2 until no more outliers are found, or a pre-determined fraction of all points have been rejected.

Embodiments of the present invention provide polynomial model-based methods for eye gaze tracking that balance accuracy and generality, and which are useful for various technical applications, such as human attention analysis, human cognitive state analysis and gaze-based human-computer interaction. Embodiments of the invention determine gaze of a subject using images from conventional off the shelf (COTS) cameras. This is accomplished by measuring the subject's appearance in the images, and automatically calculating the subject's face and eye pose given a set of parameters discovered during a calibration process. The autonomous functions of embodiments of the invention are performed using processors of COTS computers. The computer receives images of the subject from the camera. The computer also receives input from the subject or otherwise assume that the subject is viewing a known coordinate within a gaze target (or screen). These correspondences are used by the computer to calibrate and train the system. Parameters describing the physical arrangement of subject, camera and screen are derived using a reduced multivariate polynomial model.

Embodiments of the invention assume that the subject looks at known coordinates within the screen either because the subject is asked to as part of an active calibration task, or because the subject is using a positional input device such as a mouse or touch sensitive screen. During positional interactions such as clicking or touching when using a positional input device, it is natural for the subject to look at the pointing device cursor or intended interaction feature. In combination with a false correspondence rejection mechanism, embodiments of the invention are able to generate valid calibration correspondences and results from these coincidental interactions. This technique is referred to as “passive” calibration.

Embodiments of the invention may be implemented in a computing system that includes a back end component (eg, as a data server), or a middleware component (eg, an application server), or a front end component (eg, a client computer having a graphical user interface or a web browser through which a user may interact with an implementation of the method described above), or any combination of such back end, middleware, or front end components.

The software components may comprise a persistent service that executes continuously, and a real time service that executes only during gaze tracking. In this instance, service is synonymous with an operating system process having specific functionality. This arrangement reduces power consumption while making the service potentially available to third party applications. Embodiments of the invention may comprise software integrated into a web browser that provides an interface for configuration and control of the system, and an interface for third party software to interact with the system. The persistent service may also be used for third party software integration as described below.

Many potential applications for gaze tracking systems fall into two categories: (a) immediate use of gaze focus for user-input; or (b) offline or centralised analysis of gaze-tracking data from many subjects in different physical locations (often but not always in aggregate form). Embodiments of the invention may provide two application program interfaces (APIs) for third party systems. These interfaces may be implemented, for example, using HTTP and JavaScript. Other equivalent application protocols for distributed, collaborative, hypermedia information systems, or dynamic computer programming languages, may also be used.

The persistent service may be provided as a HTTP server. The persistent service may be sent HTTP requests for gaze tracking data, and configure and control the gaze tracking system. The HTTP requests may be sent from any computer.

Javascript is a programming environment that is featured on most modern we browser software. Javascript code runs inside the user's web browser software. A separate Javascript context is created for each web page being viewed. Embodiments of the invention may be implemented as a Javascript interface to allow page content to interact with gaze data, and to configure and control the gaze tracking system.

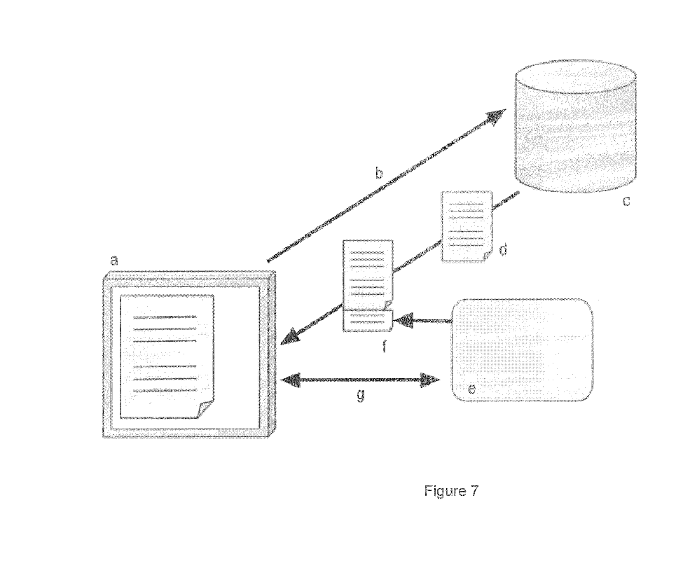

FIG. 7 illustrates example system architectures for providing these interfaces to enable third party software developers to easily integrate gaze tracking into their applications. Embodiments of the invention may provide two methods for third parties to integrate gaze-tracking data into their systems. In the first method, the persistent web service may be queried via HTTP requests. In the second method, a browser extension may inject Javascript code into every web page displayed by the browser. This code may contain functions that allow the page to connect with and use gaze data. The code may also query to see if the gaze tracking service is available on the user's computing device.

There are several benefits to this approach. First, the user only needs to install the gaze tracking system once. Third party software developers do not need to package the system with their applications. This reduces barriers to widespread adoption of the technology, because each application of gaze tracking does not require a software installation. Second, the third party developer may easily integrate this data into their application either without an understanding of how the gaze tracking system works, or without having to develop communications libraries to exchange data with the gaze tracking system. Third, the gaze tracking system is seamlessly integrated into the same runtime environment as the third party code. This reduces the complexity and time required to develop third party applications. Fourth, third party software developers may use a web based language such as Javascript to build applications even though this language is not suitable for gaze tracking, because it requires real time video processing and/or interaction with specific hardware devices. Security models in modern distributed systems (such as web applications) typically prevent remote applications (such as web pages) from interacting with hardware on local computers.

FIG. 7 illustrates an example software architecture for gaze-enhanced software that allows developers of user interfaces (such as internet applications or content) to include gaze tracking data in the interface without requiring users to download and install a separate gaze tracking system for every software application. Gaze tracking may enhance the interfaces in many ways, for example, by making the appearance of the screen react to gaze changes, or be automatically selecting or highlighting content, such as online advertising, being seen by the user. In the example illustrated in FIG. 7, a web browser (a) sends a request for a page (b) to a web server (c). The server (c) responds with a web page (d). The gaze tracking system (e), if present on the user's computer, automatically adds the relevant functional interfaces (f) to the page before it is received by the browser. One way this may be achieved is using JavaScript injection via a browser extension library. With the additional functional interfaces (f), gaze tracking commands in the original page (d) may be connected (g) to the gaze tracking system (e).

Embodiments of the invention may also provide interfaces for central collection of distributed gaze tracking data. The second class of gaze tracking applications described above includes user-experience research, collection of advertising effectiveness data, user interface design experiments, academic research into attentional processing, online training tools, and many other uses. In many of these applications, the third party wishes to discover how users view content such as websites, graphics, designs, advertising materials, images, videos, or other media. The content is shown to many users and their gaze tracking data while viewing the content is collected and analysed centrally. Most existing gaze tracking systems use dedicated hardware, and therefore users are typically brought to this equipment. However, some web-based services exist that perform gaze tracking for distributed populations of users. However, these services typically require third parties to provide the content to the gaze tracking service, which is then relayed to users.

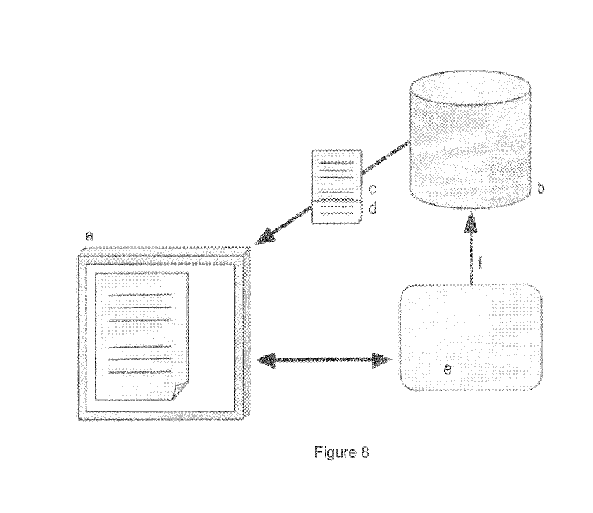

Embodiments of the invention also provide an example software architecture for central collection of distributed gaze tracking data. As illustrated in FIG. 8, a third party may include instructions for the gaze tracking system as part of their content. If the gaze tracking system is available, the user's gaze data will be returned to the content provider directly. This approach has the benefit that the gaze tracking system need only be installed once, and thereafter it is easy for third parties to request gaze tracking data from any user. Very little difficulty is imposed on third parties wishing to collect gaze data. Embodiments of the invention may include a feature that requires user consent for remote collection of any gaze data. The user configures the local gaze-tracking system according to their preferences, and may select explicit consent to allow third parties to collect data.

In the example illustrated in FIG. 8, a user's interface (such as a web browser) (a) sends a request to a central server (b) for the gaze-tracking problem (this might be a website, some images, video or other media). The content (c) is returned including gaze tracking instructions (d) that configure the gaze tracking system (e). The system is then able to communicate results directly back to the originating server (f).

Embodiments of the invention remove technological and practical barriers to widespread exploitation of gaze tracking. Since embodiments of the invention do not require any hardware except that typically fitted to computer systems, the principal barriers are access to subject gaze data in a usable form. Therefore, embodiments of the invention provide mechanisms to provide gaze data in formats that are immediately accessible to software developers, web page creators and businesses via software interfaces.

The above embodiments have been described by way of example only and modifications are possible within the scope of the claims that follow.

1. A method, comprising:
(a) measuring coordinates of four or five fiducial markers in facial images of a subject captured by a camera facing away from a screen toward the subject;
(b) optimising and reducing a multivariate polynomial model that maps the measured coordinates of the four or five fiducial markers in the facial images to estimated coordinates of gaze targets of the subject on the screen; and
(c) using the reduced multivariate polynomial model to map the measured coordinates of the four or five fiducial markers to the estimated coordinates of gaze targets of the subject on the screen.

2. The method of claim 1, wherein steps (a) and (c) are performed continuously, and step (b) is performed occasionally when calibration is required.

3. The method of claim 1, wherein the four or five fiducial markers comprise four or five facial landmarks that are invariant to head or face pose of the subject, non-collinear and non-parallel to an image plane of the camera.

4. The method of claim 3, wherein the four or five facial landmarks comprise left and right inner canthi, an upper lip midpoint, and either one iris centre or an average of left and right iris centres.

5. The method of claim 1, wherein the four or five facial landmarks are detected and extracted from the facial images using a face-fitting algorithm.

6. The method of claim 1, wherein the reduced multivariate polynomial model comprises a fourth order polynomial model including two fourth order polynomial functions, one of which estimates x coordinates of the gaze targets on the screen, and the other of which estimates y coordinates of the gaze targets on the screen.

7. The method of claim 1, wherein step (b) comprises starting with an initial polynomial function having a large number of terms, and iteratively removing terms and measuring prediction error until an optimal combination of prediction error and generalisation is achieved.

8. The method of claim 7, wherein the optimal combination of prediction error and generalisation is achieved by removing terms until interim prediction error is greater than a predetermined fraction of original prediction error using all terms.

9. The method of claim 8, wherein the order of term removal is determined by a greedy search over all terms, and removing individual terms that have least impact on accuracy for all terms.

10. The method of claim 1, further comprising calibrating or training the reduced multivariate polynomial model by measuring image coordinates of the four or five fiducial markers when there is a high probability that the subject is gazing at known screen coordinates either incidentally or as a feature of a user interface.

11. The method of claim 10, wherein the known gaze targets comprise cursor indicators, user selectable items or content objects displayed at known coordinates on the screen.

12. The method of claim 1, wherein the screen is a display of a computing device.

13. The method of claim 12, wherein the computing device comprises a computer, a tablet or a smartphone.

14. The method of claim 1, wherein the camera is a video camera or a webcam.

15. A computer program product stored on a non-transitory tangible computer readable medium and comprising instructions that, when executed, cause a computer system to:
(a) measure coordinates of four or five fiducial markers in facial images of a subject captured by a camera facing away from a screen toward the subject;
(b) optimise and reduce a multivariate polynomial model that maps the measured coordinates of the four or five fiducial markers in the facial images to estimated coordinates of gaze targets of the subject on the screen; and
(c) use the reduced multivariate polynomial model to map the measured coordinates of the four or five fiducial markers to the estimated coordinates of gaze targets of the subject on the screen.
